(19) United States
(12) Patent Application Publication
(10) Pub. No.: US 2024/0190042 A1
(43) Pub. Date: Jun. 13, 2024

(54) DEVICE AND METHOD FOR COMPACTING CERAMIC MATERIAL

(71) Applicant: SYSTEM CERAMICS S.P.A., FIORANO MODENESE (MODENA) (IT)

(72) Inventors: FRANCO STEFANI, Sassuolo (Modena) (IT); Eustachio Tarasco, Bologna (IT); Franco Gozzi, Formigine (Modena) (IT); Andrea Gozzi, Formigine(Modena) (IT)

(21) Appl. No.: 18/551,045

(22) PCT Filed: Mar. 23, 2022
(86) PCT No.: PCT/IB2022/052635

§ 371 Date: Sep. 18, 2023

(30) Foreign Application Priority Data
Mar. 29, 2021 (IT) 102021000007613

(51) Int. Cl. B28B 3/00; B28B 5/02

(52) U.S. Cl. CPC B28B 3/00; B28B 5/02

(57) ABSTRACT

A pressing device for pressing a layer of ceramic material, comprising:
a press (10), provided with a lower pad (11), provided with a pressing surface (11a) facing upwards and arranged below the active portion (3) of a first movable belt (2), and an upper pad (12), provided with a pressing surface (12a) facing downwards and arranged above the active portion (3) of the first movable belt (2);
a compactor (20), arranged upstream of the press (10), which comprises a lower presser (21), provided with a pressing surface (21a) facing upwards, which is arranged below the active portion (3) of a first movable belt (2), and an upper presser (22), provided with a pressing surface (22a) facing downwards, which is arranged above the active portion (3) of the first movable belt (2).
The pressers (21,22) of the compactor (20) can be activated independently of the pads (11,12) of the press (10).

The present invention relates to a device and a method for compacting ceramic material.

The invention relates in particular to the part of the technological process for producing ceramic tiles in which the compacting or pressing of the ceramic material is carried out for forming slabs which are subsequently subjected to the decorating steps and the firing step.

The compacting or pressing of ceramic material substantially envisages subjecting the ceramic material to a flat compression, to obtain a slab in which the granules and particles of ceramic material are pressed together as much as possible, i.e. with the minimal amount of air trapped inside the slab.

The compacting of ceramic material typically takes place with the aid of presses. Apart from presses conformed like an extruder, which compress the material by making it advance between two flat, static and converging surfaces, the presses normally comprise pressers or pads, moving towards and away from each other, which define a pressing compartment between them. The ceramic material is supplied to the pressing compartment in layer form and, subsequently, the pressers are moved towards each other so as to compress the layer of ceramic material with a predetermined pressure.

The applicant devised a press, which is well known in the sector, comprising a conveyor belt, movable along a path, a horizontal and rectilinear portion of which passes through the pressing compartment delimited by an upper pad and by a lower pad. The ceramic material is spread, in the form of a layer, onto said conveyor belt, and is guided, by the latter, into the pressing compartment. The pressing of the layer of ceramic material takes place directly on the conveyor belt during a stopping step whose duration depends on the time required by the press for performing its pressing cycle.

Both in the press devised by the applicant, and in other pad presses, the pressing cycle involves six main steps. Such steps are carried out after the entry of a layer of ceramic material into the pressing compartment.

A first step substantially involves the nearing of the two pressers, starting from an initial position, in which they are further apart from each other to enable the entry of the material to be pressed, to a final position, in which both are in contact with the material to be pressed.

A second step, also known as pre-compacting, involves a first compression of material, to a predetermined pressure and for a predetermined time. During this step, a part of the trapped air escapes the material, mainly from the side areas of the layer. A part of the air remains instead trapped in the surface areas in contact with or near to the pressing surfaces of the two pressers.

The third step of the cycle, also known as deaeration, involves reducing the pressure and moving the two pressers away from each other, for a predefined time, so as to create a passageway that promotes the exit of air still trapped close to the surface areas.

Overall, the first three steps of the process take between 2 and 3 seconds.

In the fourth step of the cycle, the maximum compacting of the material takes place, with the application of the maximum pressures envisaged.

The fifth and sixth step are essentially unloading steps. The fifth step envisages the release of the pressure applied to the two pressers, until detachment of the material, whereas the sixth step envisages the return of the pressers to the initial position. The second three steps of the cycle normally take between 4 and 5 seconds.

The second and third step of the compacting cycle, i.e. the pre-compacting and deaeration, are essential for the performance of the subsequent steps of the production process. In fact, the air trapped in the ceramic material, if not correctly evacuated, causes damage that can occur both during the press unloading steps, due to the sudden expansion of the bubbles positioned near the surface of the pressed layer, and during the firing of the slabs. In the latter case, the air bubbles trapped inside the slabs expand explosively, causing the slabs to break.

So that the air trapped in the ceramic material can escape in a uniform and complete way, the pre-compacting and deaerating steps must be performed for a sufficiently prolonged amount of time. Typically, the two steps take at least 2.5 seconds in order to produce a sufficient result. As the thickness of the layer of ceramic material to be pressed increases, or in the presence of particularly aerated materials, more time is required.

In current presses, the time taken for the pre-compacting and deaerating steps is added to the duration of the compacting and unloading steps, causing an increase in the total time for the pressing cycle. Furthermore, the deaerating step, which envisages the mutual distancing of the pressers, implies energy expenditure due to the displacement of the pressers themselves which, after being moved away, must be moved towards each other again for the compacting step.

The object of the present invention is that of offering a device and method for compacting ceramic materials that enables the current technology to be improved.

The main advantage of the invention is that it enables the productivity of the pressing cycle to be notably increased, increasing the number of slabs pressed per unit of time.

Another advantage of the invention is that the quality of the pre-compacting and deaerating steps is improved, increasing the amount of air evacuated from the ceramic material.

Additional features and advantages of the present invention will become more apparent from the following detailed description of an embodiment of the invention, illustrated by way of non-limiting example in the appended figures, in which:

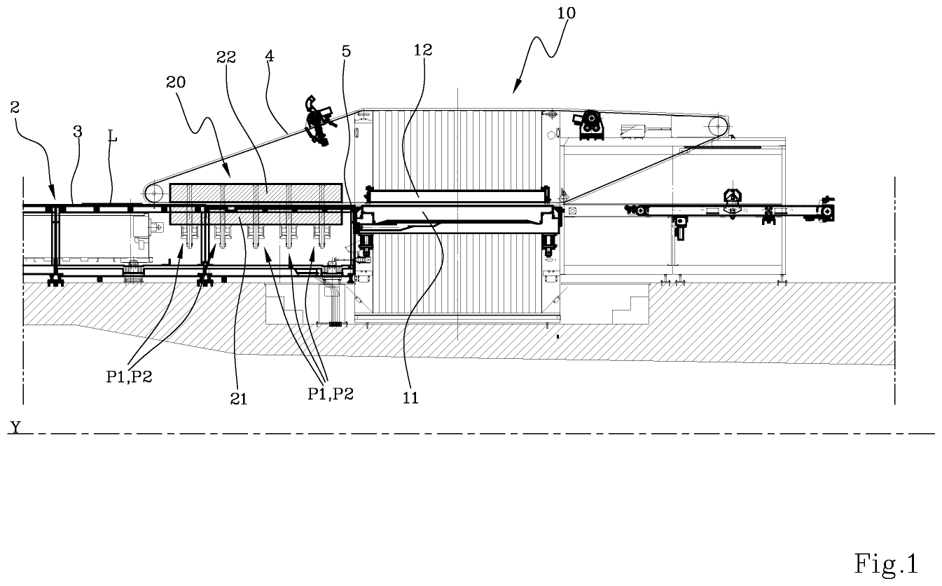

FIG. 1 illustrates a schematic view in vertical elevation of the device according to the present invention;

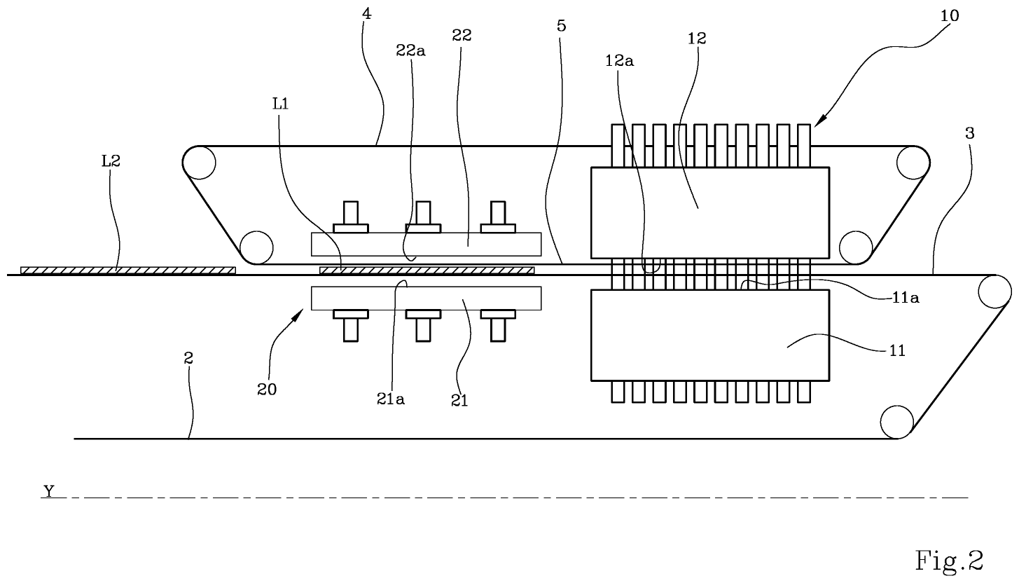

FIG. 2 shows the device according to the present invention, in a simplified representation for showing a first operating configuration;

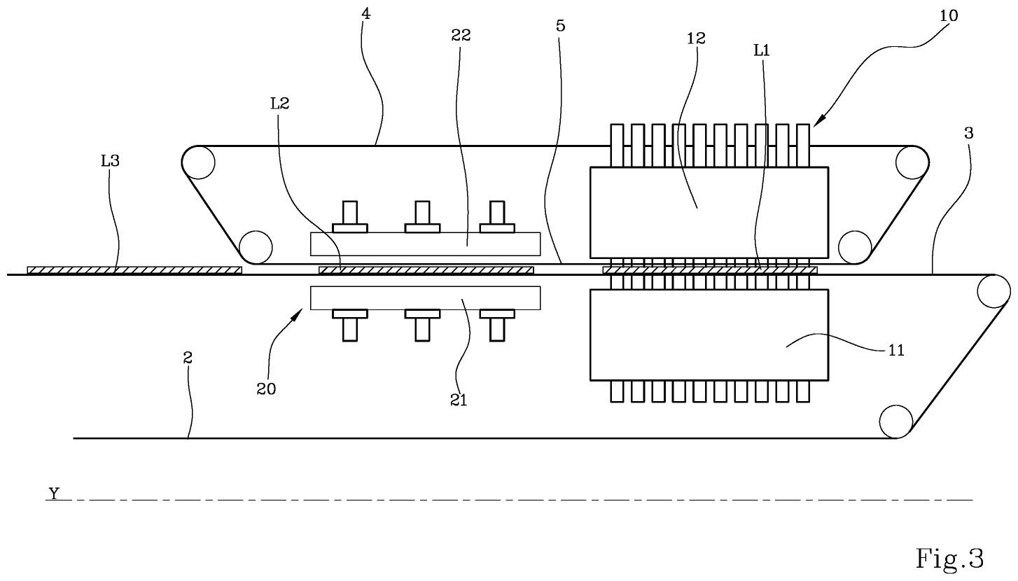

FIG. 3 shows the device of FIG. 2 in a subsequent operating configuration.

The device for pressing a layer of ceramic material according to the present invention, comprises a first movable belt (2), comprising an active portion (3) substantially horizontal and movable along an advancement direction (Y). The active portion (3) substantially defines a support surface facing upwards, on which the ceramic material to be pressed can be deposited.

The device according to the invention further comprises a press (10), provided with a lower pad (11) and an upper pad (12). Overall, the press (10) is known in the sector.

The lower pad (11) is provided with a pressing surface (11a) facing upwards and arranged below the active portion (3) of the first movable belt (2).

The upper pad (12) is provided with a pressing surface (12a) facing downwards and is arranged above the active portion (3) of the first movable belt (2).

In a known way, the two pads (11,12) can be activated to move towards each other, starting from a rest position, so as to carry out the pressing of a layer (L) of ceramic material by applying a predetermined pressing load.

The active portion (3) is arranged, at least for a part of the extension thereof, between the upper pad (12) and the lower pad (11). The active portion (3) of the first belt (2) is movable along an advancement direction (Y) for feeding the layers (L) of material to be pressed into the space comprised between the two pads (11,12). The layers (L) to be pressed are deposited on the first belt (2) upstream of the two pads, using known means to the person skilled in the art and not illustrated in detail. The first belt (2) is activated by means of rollers (R) arranged in relation to the pathway to be followed, in a known way in the art. The rollers have been only schematically represented in the figures.

During the feeding of a layer (L) to the press (10), the pads (11,12) are separated by a greater distance to allow the entry of the layer (L) into the space comprised between the same pads. To carry out the pressing, the pads (11,12) move towards each other until entering into contact with the layer (L) positioned on the active portion (3) of the first belt (2), progressively exerting the pressing load. Once the pressing is finished, the pads are moved away from each other carrying out the step of unloading the layer (L) and returning to the rest position.

The motion performed by the first belt (2) is a step-by-step motion. In substance, the first belt (2) advances at a sufficient pitch to place the layer (L) between the pads (11,12) and it stops while waiting for the pads (11,12) to perform the operating cycle. At the end of the operating cycle carried out by the pads (11,12), the first belt (2) starts to move again and performs a subsequent step for placing a subsequent layer (L) between the pads (11,12).

Advantageously, the device according to the present invention, comprises a compactor (20), arranged upstream of the press (10). The compactor comprises a lower presser (21) and an upper presser (22).

The lower presser (21) is provided with a pressing surface (21a) facing upwards and arranged below the active portion (3) of the first movable belt (2).

The upper presser (22) is, in turn, provided with a pressing surface (22a) facing downwards and is arranged above the active portion (3) of the first movable belt (2).

The two pressers (21,22) can be activated to move towards each other, starting from a rest position, so as to carry out the compacting of a layer (L) of ceramic material by applying a load which is lower than the pressing load.

In substance, as well as between the two pads (11,12), the active portion (3) is arranged, at least for a part of the extension thereof, also between the upper presser (22) and the lower presser (21), which are arranged upstream of the pads (11,12) with respect to the advancement direction of the active portion (3). The active portion (3) is movable along the advancement direction (Y) for feeding the layers (L) of material to be pressed into the space comprised between the two pressers (21,22). The layers (L) to be pressed are deposited on the first belt (2) upstream of the two pressers (21,22).

In practice, the active portion (3) of the first movable belt (2) is arranged, at least for a part of the extension thereof, both between the pressers (21,22) and between the pads (11,12).

The work cycle carried out by the pressers (21,22) is similar overall to the work cycle carried out by the pads (11,12), and precedes the action of the pads (11,12). Furthermore, the compacting load applied to the pressers (21,22) is less than the pressing load applied by the pads (11,12) to the layer (L).

Advantageously, the pressers (21,22) of the compactor (20) can be activated independently of the pads (11,12) of the press (10). In this way, for the same layer (L) it is possible to perform the steps of pre-compacting and deaerating by means of the compactor (20). At the end of these two steps, the layer (L) can be transferred to the press (10), for carrying out the pressing and unloading steps.

In particular, the compactor (20) carries out the following steps.

A first step, in which the pressers (21,22) move towards each other, starting from a rest position, in which they are further apart from each other to enable the entry of a layer (L) to be pressed, to a final position, in which both are in contact with the material to be pressed.

A second step, i.e. the pre-compacting step, in which the pressers (21,22) carry out a first compression of the material, to a pressure corresponding to the compacting load and for a predefined time. During this step, a part of the trapped air escapes the material, mainly from the side areas of the layer (L). The compacting load is equivalent to a pressure of about 30 bar.

A third step of the cycle, i.e. the deaerating step, involves reducing the pressure and moving the two pressers away from each other, for a predefined time, so as to create a passageway that promotes the exit of air still trapped close to the surface areas of the layer (L).

The first three steps of the process normally take between 2 and 3 seconds.

After the three steps summarised above are finished, the layer (L) is transported to the press (10), while a new layer (L) is fed to the compactor (20).

The press (10) carries out the following steps on the layer (L) which has already undergone the compacting by the compactor (20).

In a fourth step the maximum compacting of the material takes place, i.e. pressing, with the application of the maximum pressures envisaged corresponding to the envisaged pressing load. The layer (L) enters the press (10) after having already undergone the pre-compacting process, with a remarkable reduction in thickness. The pads (11,12) can therefore remain closer to each other in the rest position, given that the thickness of the layer (L) has already been reduced, and therefore travel a shorter stroke with respect to what happens in the presses currently available. The pressing load is equivalent to a pressure of about 400 bar.

A fifth and sixth step are essentially unloading steps. The fifth step envisages the release of the pressure applied to the two pads (11,12), until detachment of the material, whereas the sixth step envisages the return of the pads to the initial position. Also the distancing stroke travelled by the pads (11,12), for the reasons explained above, is shorter than what happens in the presses currently available. Overall, the third, fourth and fifth step of the process take between 4 and 5 seconds.

Advantageously, the separation between the compactor (20) and the press (10) enables the related steps of the process to be performed in parallel, on two distinct layers (L) of ceramic material to be pressed, enabling the productivity of the process to be increased.

In substance, while a first layer (L1) is transferred from the compactor (20) to the press (10), a subsequent layer (L2) is fed to the compactor (20). In such conditions, the press (10) and the compactor (20) are activated almost simultaneously, so that the steps of pre-compacting and deaerating the second layer (L2) are performed substantially simultaneously with the steps of pressing and unloading the first layer (L1). It is therefore fully clear how, for the same amount of total cycle time, the number of layers processed is notably increased with respect to a traditional device provided with just one press. In particular, with the same amount of material and thickness of the layer to be pressed, the productivity of the device increases by about 40% with respect to a current press.

Furthermore, given that the steps carried out by the press (10) take longer than the steps carried out by the compactor (20), it is possible to increase the time dedicated to the steps carried out by the compactor (20), making it equal to the time required by the steps carried out by the press. Increasing the time dedicated to pre-compacting and deaeration causes a notable increase in the air evacuated from the layer (L), to the advantage of the quality of the finished product.

An example of a work cycle that can be carried out with the device according to the present invention is as follows.

Starting from an initial empty configuration, the pressers (21,22) and the pads (11,12) are in the rest position, separated by a greater distance to enable the entry of a first layer (L1) of the production cycle into the space comprised between the pressers (21,22). To compact the first layer (L1), the pressers (21,22) move towards each other until they come into contact with the first layer (L1), gradually exerting the compacting load, with a predetermined time course depending on the material and thickness of the layer itself. After reaching the envisaged compacting load, the pressers (21,22) move away from each other for deaerating the first layer (L1), i.e. to enable the escape of the air trapped in the first layer (L1). During the pre-compacting of the first layer (L1), the press (10) can remain substantially inactive. Obviously, under normal working conditions, the press (10) does not remain inactive.

In fact, after the step of deaerating the first layer (L1) has been completed, a second layer (L2), previously spread onto the active portion (3) of the first belt (2), is fed to the compactor (20) while the first layer (L1) is transferred from the compactor (20) to the press (10). After reaching the respective positions between the pressers (21,22) and the pads (11,12), the second layer (L2) and the first layer (L1) are subjected to the steps of pre-compacting and pressing, respectively, substantially simultaneously. After the work cycles of the press (10) and the compactor (20) have both finished, the first layer (L1) is moved away from the press (10), the second layer (L2) is transferred from the compactor (20) to the press (10), while a third layer (L3), previously deposited on the active portion (3) of the first belt (2), is fed to the compactor (20). At this point, the second and third layer (L2,L3) are subjected, substantially simultaneously, to the work cycles of the press (10) and the compactor (20). The steps described are repeated for the layers fed in succession for the duration of the production cycle.

The displacements of the various layers (L1,L2,L3) described above all take place by means of the first belt (2). Such displacements are therefore simultaneous. For that purpose, the various layers (L1,L2,L3) are deposited onto the active portion (3) of the first belt (2) separated by a distance, measured parallel to the advancement direction (Y), substantially equal to the distance that separates the compactor (20) and the press (10), so that the first belt (2) can simultaneously position a layer at the compactor (20) and another layer at the press (10).

In an alternative embodiment, a layer (L) does not necessarily pass directly from the compactor (20) to the press (10) with a single advancement step of the first belt (2), but it could be possible to distance the compactor (20) further away from the press (10) so that during the production cycle one or more consecutive layers can be positioned which are taken to the press (10) in subsequent steps. In other words, under normal working conditions, for every advancement step of the first belt (2) there will be a layer (L) that is fed to the compactor (20) and, simultaneously, another layer (L) that is fed to the press (10). Between these two layers there will be one or more layers that are fed to the press (10) step by step.

An oil-hydraulic unit is predisposed to activate the two pressers (21,22) of the compactor (20). For example, an oil-hydraulic unit comprises two or more pistons (P1,P2) associated with the pressers (21,22) in a substantially known way. The pistons (P1,P2) may be distributed symmetrically with respect to a median plane, vertical and parallel to the advancement direction (Y) of the pressers (21,22). Various examples of an oil-hydraulic unit suitable for activating the pressers (21,22) are available to a person skilled in the art, and shall not be described in detail.

In a preferred configuration the pistons (P1,P2) are associated either with the lower presser (21) only or with the upper presser (22) only.

Preferably, but not necessarily, the pressing device preferably comprises a second movable belt (4) provided with an active portion (5) arranged at least partially between the active portion (3) of the first movable belt (2) and the upper pad (11). The active portion (5) of the second movable belt (4) is therefore arranged between the upper presser (22) and the active portion (3) of the first movable belt (2). The active portion (5) of the second movable belt (4) is movable along the advancement direction (Y) in accordance with the active portion (3) of the first belt (2). At least for a portion arranged at the pressers (21,22) and at the pads (11,12), and partially upstream and downstream thereof, the two active portions (3,5) are both parallel to the advancement direction (Y). The second belt (4) is also activated by means of rollers (R) arranged in relation to the pathway to be followed, in a known way in the art. The rollers have been only schematically represented in the figures.

In this configuration the active portions (3,5) are parallel to one another and are separated by a distance which enables the entry of the charge (L), the thickness of which, i.e. the height measured perpendicularly to the support surface of the lower active portion (3), is smaller than the distance separating the active portions (3,5).

The movable belts (2,4) move at a controlled speed. The movable belts (2,4) preferably move in a synchronised way and at the same speed. A control device known to a person skilled in the art can be predisposed for the correct relative positioning of the movable belts (2,4). During the steps of displacing the layers (L), the pressers (21,22) and the pads (11,12) are in the respective rest positions, i.e. they are separated by a distance such as to enable the entry of the layers (L) into the space comprised between the pressers and the pads themselves.

The second belt (4) can be configured with an overall length that is shorter than the first belt (2). In practice, the second belt (4) is closed along an annular path the total length of which is shorter than that of the path followed by the first belt (2). At the two active portions (3,5), the two paths are parallel to the advancement direction (Y). At the exit from the press (10), along a portion of the path different from the active portion (5), the second belt (4) is subjected to cleaning, to remove any residues of ceramic material.

The device according to the present invention enables a method to be carried out for pressing a layer of ceramic material, comprising following steps:
arranging a first layer (L1) of ceramic material on the active portion (3) of a first movable belt (2);
activating the first movable belt (2) to make the active portion (3) advance along an advancement direction (Y) and position the first layer (L1) between two pressers (21,22) of a compactor (20);
activating the two pressers (21,22) to move towards one another to compact the first layer (L1) by applying thereon a predetermined compacting load;
activating the two pressers (21,22) to move away from one another to release the first layer (L1);
activating the first movable belt (2) again in order to position the first layer (L1) between two pads (11,12) of a press (10), arranged downstream of the compactor (20) along the advancement direction (Y), and to position a second layer (L2) of ceramic material, previously deposited on the active portion (3), between the pressers (21,22) of the compactor (20);
activating the pads (11,12) to move towards one another in order to press the first layer (L1) by applying a predetermined pressing load greater than the compacting load;
activating the pressers (21,22) to move towards one another to compact the second layer (L2) by applying the pre-compacting load, in a substantially simultaneous way with the pads (11,12);
activating the pads (11,12) and the pressers (21,22) to move away from one another in a substantially simultaneous way in order to release the first and second layer (L1,L2);
activating the first movable belt (2) again to move the first layer (L1) away from the pads (11,12) and to position the second layer (L2) between the pads (11,12);
activating the pads (11,12) to move towards one another in order to press the second layer (L2) by applying said pressing load.

Preferably, the method comprises the following further steps: arranging a third layer (L3) on the active portion (3) of the first belt (2), upstream of the second layer (L2), in a position such that the third layer (L3) is positioned between the pressers (21,22) when the second layer (L2) is positioned between the pads (11,12).

Preferably, the method comprises the steps of arranging further layers of ceramic material, consecutively to one another, so that, considering two consecutive layers, one layer can be positioned between the pads (11,12) and the upstream layer can simultaneously be positioned between the pressers (21,22).

1. A pressing device for pressing a layer of ceramic material, comprising:
a first movable belt (2), comprising an active portion (3) substantially horizontal and movable along an advancement direction (Y);
a press (10), provided with:
a lower pad (11), provided with a pressing surface (11a) facing upwards and arranged below the active portion (3) of the first movable belt (2);
an upper pad (12), provided with a pressing surface (12a) facing downwards and arranged above the active portion (3) of the first movable belt (2);
wherein the two pads (11,12) can be activated to move towards each other so as to carry out the pressing of a layer (L) of ceramic material by applying a predetermined pressing load;
the pressing device comprises a compactor (20), arranged upstream of the press (10), which comprises:
a lower presser (21), provided with a pressing surface (21a) facing upwards and arranged below the active portion (3) of the first movable belt (2);
an upper presser (22), provided with a pressing surface (22a) facing downwards and arranged above the active portion (3) of the first movable belt (2);
wherein the two pressers (21,22) can be activated to move towards each other so as to carry out the compacting of a layer (L) of ceramic material by applying a compacting load which is lower than the pressing load;
wherein the pressers (21,22) of the compactor (20) can be activated independently of the pads (11,12) of the press (10).

2. The device according to claim 1, comprising an oil-hydraulic unit arranged to activate the two pressers (21,22) of the compactor (20).

3. The device according to claim 2, wherein said oil-hydraulic unit comprises two or more pistons (P1,P2), associated with the lower presser (21) and/or the upper presser (22).

4. The device according to claim 1, comprising a second movable belt (4), comprising an active portion (5) movable along the advancement direction (Y) and substantially parallel to and superimposed on the active portion (3) of the first movable belt (2), wherein the upper presser (22) and the upper pad (12) are arranged above the active portion (5) of the second movable belt (4).

5. The device according to claim 1, wherein the active portion (3) of the first movable belt (2) is arranged, at least for a part of the extension thereof, both between the pressers (21,22) and between the pads (11,12).

6. A pressing method for pressing a layer of ceramic material, comprising following steps:
arranging a first layer (L1) of ceramic material on the active portion (3) of a first movable belt (2);
activating the first movable belt (2) to make the active portion (3) advance along an advancement direction (Y) and position the first layer (L1) between two pressers (21,22) of a compactor (20);
activating the two pressers (21,22) to move towards one another to compact the first layer (L1) by applying thereon a predetermined compacting load;
activating the two pressers (21,22) to move away from one another to release the first layer (L1);
activating the first movable belt (2) again in order to position the first layer (L1) between two pads (11,12) of a press (10), arranged downstream of the compactor (20) along the advancement direction (Y), and to position a second layer (L2) of ceramic material, previously deposited on the active portion (3), between the pressers (21,22) of the compactor (20);
activating the pads (11,12) to move towards one another in order to press the first layer (L1) by applying a predetermined pressing load greater than the compacting load;
activating the pressers (21,22) to move towards one another to compact the second layer (L2) by applying the compacting load, in a substantially simultaneous way with the pads (11,12);
activating the pads (11,12) and the pressers (21,22) to move away from one another in a substantially simultaneous way in order to release the first and second layer (L1,L2) of ceramic material;
activating the first movable belt (2) again to move the first layer (L1) away from the pads (11,12) and to position the second layer (L2) between the pads (11,12);
activating the pads (11,12) to move towards one another in order to press the second layer (L2) by applying said pressing load.

7. The method according to claim 6, comprising following further steps: arranging a third layer (L3) on the active portion (3) of the first belt (2), upstream of the second layer (L2), in a position such that the third layer (L3) is positioned between the pressers (21,22) when the second layer (L2) is positioned between the pads (11,12).

8. The method according to claim 7, comprising steps of arranging further layers of ceramic material, consecutively to one another, so that, considering two consecutive layers, one layer can be positioned between the pads (11,12) and the downstream layer can simultaneously be positioned between the pressers (21,22).
